(19) United States
(12) Patent Application Publication
(10) Pub. No.: US 2026/0236853 A1
(43) Pub. Date: Aug. 13, 2026

(54) MODEL TRAINING METHOD AND APPARATUS, STORAGE MEDIUM, AND ELECTRONIC DEVICE

(71) Applicant: Alipay (Hangzhou) Information Technology Co., Ltd., Hangzhou (CN)

(72) Inventors: Qixian ZHOU, Hangzhou (CN); Yan LIU, Hangzhou (CN)

(21) Appl. No.: 19/155,932

(22) PCT Filed: Dec. 26, 2023
(86) PCT No.: PCT/CN2023/141802

§ 371 Date: Aug. 12, 2025

(30) Foreign Application Priority Data
Mar. 10, 2023 (CN) 202310252668.4

(51) Int. Cl. G06N 20/20; G06F 21/57; G06F 21/60

(52) U.S. Cl. CPC G06N 20/20; G06F 21/577; G06F 21/602

(57) ABSTRACT

This specification discloses a model training method and apparatus, a storage medium, and an electronic device. For each worker unit in a training system, an encryption function is determined by using a gradient of the worker unit as a parameter; and sliced encrypted data that is of the gradient and that corresponds to a specified value is determined based on the encryption function. Further, a gradient sum of another worker unit and the worker unit is determined based on the sliced encrypted data that is of the gradient and that corresponds to the specified value and sliced encrypted data that is of a gradient of the another worker unit and that corresponds to the specified value, to complete gradient aggregation, and then a model training task is completed based on an aggregated gradient.

### TECHNICAL FIELD

This specification relates to the field of computer technologies, and in particular, to a model training method and apparatus, a storage medium, and an electronic device.

### BACKGROUND

With development of computer technologies and people's increasing attention to their own privacy data, use of federated learning for model training has been widely applied to the field of model training.

A federated learning system usually includes a plurality of worker nodes and a parameter server. Each worker node stores different data, and the parameter server stores a model parameter. When a model training task needs to be executed, the worker node determines a model gradient based on a model parameter delivered by the parameter server, a training sample stored in the worker node, and a pre-deployed model structure, and returns the model gradient to the parameter server. The parameter server updates, based on the received model gradient sent by each worker node, the model parameter stored in the parameter server, and sends an updated model parameter to each worker node, to complete the model training task.

However, when the parameter server is untrusted, there is a case in which the parameter server infers the training sample in each worker node based on the model parameter stored in the parameter server and the gradient. Consequently, there is a potential security risk to the training sample in each worker node.

Based on this, this specification provides a model training method.

### SUMMARY

This specification provides a model training method and apparatus, a storage medium, and an electronic device, to partially resolve the above-mentioned problems existing in a related technology.

This specification uses the following technical solutions: This specification provides a model training method. The method is applied to a training system, the training system includes several worker units, and each worker unit stores a different training sample. The method includes: for each worker unit, determining, in response to a model training task, a gradient based on the training sample stored in the worker unit; determining, by using the gradient as a parameter of an encryption function, an encryption function corresponding to the worker unit; for each specified value, determining, as first encrypted data based on the specified value and the encryption function, sliced encrypted data that is of the gradient and that corresponds to the specified value, where a quantity of specified values is not less than a quantity of worker units that execute the model training task; receiving sliced encrypted data that is sent by another worker unit, that is of a gradient of the another worker unit, and that corresponds to the specified value, and using the sliced encrypted data as second encrypted data; and obtaining a gradient sum of the another worker unit and the worker unit through decryption based on sliced encrypted data corresponding to all the specified values, and executing the model training task based on the gradient sum.

This specification provides a model training apparatus. The apparatus is applied to a model training system, the training system includes several worker units, and each worker unit stores a different training sample. The apparatus includes: a gradient determining module, configured to: for each worker unit, determine, in response to a model training task, a gradient based on the training sample stored in the worker unit; a function determining module, configured to determine, by using the gradient as a parameter of an encryption function, an encryption function corresponding to the worker unit; a slice determining module, configured to: for each specified value, determine, as first encrypted data based on the specified value and the encryption function, sliced encrypted data that is of the gradient and that corresponds to the specified value, where a quantity of specified values is not less than a quantity of worker units that execute the model training task; a receiving module, configured to: receive sliced encrypted data that is sent by another worker unit, that is of a gradient of the another worker unit, and that corresponds to the specified value, and use the sliced encrypted data as second encrypted data; and an execution module, configured to: determine a gradient sum of the another worker unit and the worker unit based on sliced encrypted data corresponding to all the specified values, and execute the model training task based on the gradient sum.

This specification provides a non-transitory computer-readable storage medium. The storage medium stores a computer program, and when the computer program is executed by a processor, the model training method is implemented.

This specification provides an electronic device, including a storage, a processor, and a computer program that is stored in the storage and that is capable of running on the processor. When the processor executes the program, the model training method is implemented.

The above-mentioned at least one technical solution used in this specification can achieve the following beneficial effects: According to the model training method provided in this specification, for each worker unit, an encryption function is determined by using a gradient of the worker unit as a parameter; then sliced encrypted data that is of the gradient and that corresponds to a specified value is determined based on the encryption function; sliced encrypted data that is sent by another worker unit, that is of a gradient of the another worker unit, and that corresponds to the specified value is received; and further a gradient sum of the another worker unit and the worker unit is determined based on sliced encrypted data corresponding to all specified values, to complete gradient aggregation, and then a model training task is completed based on an aggregated gradient.

An execution process of the model training method does not require participation of a parameter server. Therefore, even if the parameter server is untrusted, related information of a training sample and a model parameter in the worker unit cannot be stolen, thereby ensuring information security of the training sample and the model parameter.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification. In the accompanying drawings:

FIG. 1 is a schematic flowchart of a model training method according to this specification;

FIG. 2 is a schematic structural diagram of a model training apparatus according to this specification; and

FIG. 3 is a schematic diagram of an electronic device corresponding to FIG. 1 according to this specification.

### DESCRIPTION OF EMBODIMENTS

To make the objectives, technical solutions, and advantages of this specification clearer, the following clearly and comprehensively describes the technical solutions of this specification with reference to specific embodiments and accompanying drawings of this specification. Clearly, the described embodiments are merely some but not all of the embodiments of this specification. All other embodiments obtained by a person of ordinary skill in the art based on the embodiments of this specification without creative efforts shall fall within the protection scope of this specification.

It should be noted that all actions of obtaining a signal, information, or data in this specification are performed in compliance with corresponding data protection regulations and policies of the local country, and are authorized by owners of corresponding apparatuses.

Deep learning is an important branch of computer science and artificial intelligence, and is a further extension of a neural network. By automatically learning effective feature representations from data to improve accuracy of a prediction model, it has been widely applied to fields such as speech recognition, image recognition, and object detection.

With a dramatic increase in a deep learning data scale, in conventional model training, iterative computation can use only all hardware resources on a host on which a current process is located. However, scalability of a single machine is always limited. Therefore, when facing massive data and a model of a large scale, the single machine is inapplicable. In this case, the data or the model needs to be divided into a plurality of parts, and training is accelerated on a plurality of machines by using hardware resources on different hosts. Based on this, a manner of using a plurality of worker nodes to perform model training work in parallel is widely applied.

Federated learning is a distributed training system, and a model training process of federated learning includes the following processes.

First, several worker nodes and a parameter server are configured.

Then, the parameter server sends a model parameter stored in the parameter server to each worker node.

Then, each worker node performs model training based on a model structure stored in the worker node, a training sample allocated from a training sample set, and the model parameter sent by the parameter server, to determine a model gradient, and then sends the determined model gradient to the parameter server.

Then, the parameter server updates the model parameter based on all received model gradients, and sends an updated model parameter to the worker node.

Finally, the above-mentioned steps are repeated until model training ends.

However, when the parameter server is untrusted, there is a case in which the parameter server infers each training sample in each worker node based on the model parameter stored in the parameter server and the received gradient sent by each worker node. Consequently, there is a potential security risk to each training sample in the federated learning system.

Based on this, this specification provides a new model training method, so that the training system can complete a model training task without participation of a parameter server, to ensure security of a training sample in a worker unit.

It should be noted that a model corresponding to the model training task is usually a model in the risk control field. For the model in the risk control field, a training sample is usually determined based on sensitive data of a user. Therefore, when the parameter server is untrusted, the parameter server can infer each training sample in each worker node based on a model parameter stored in the parameter server and a received gradient sent by each worker node. Clearly, this leads to a great increase in the probability that the sensitive data of the user stored in each worker unit is exposed, and there is a potential security risk.

The technical solutions provided in the embodiments of this specification are described below in detail with reference to the accompanying drawings.

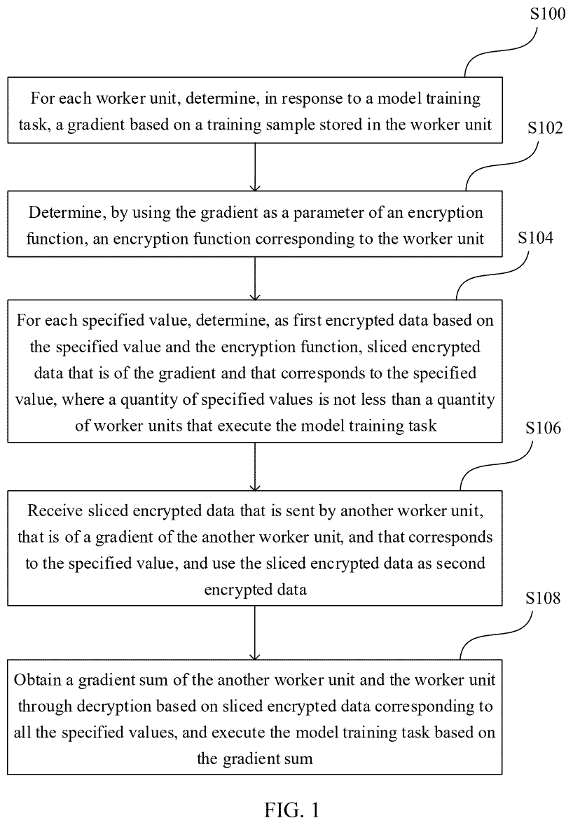

FIG. 1 is a schematic flowchart of a model training method according to this specification. The method specifically includes the following steps S100 to S108.

S100: For each worker unit, determine, in response to a model training task, a gradient based on the training sample stored in the worker unit.

Different from a current method in which a model training task is completed based on collaboration between a parameter server and each worker unit, and when the parameter server is untrusted, security of a training sample in each worker unit cannot be ensured, this specification provides a new model training method, applied to a training system that does not include a parameter server. For each worker unit in the training system, an encryption function is determined by using a gradient of the worker unit as a parameter; and sliced encrypted data that is of the gradient and that corresponds to a specified value is determined based on the encryption function. Further, a gradient sum of another worker unit and the worker unit is determined based on the sliced encrypted data that is of the gradient and that corresponds to the specified value and sliced encrypted data that is of a gradient of the another worker unit and that corresponds to the specified value, and then a model training task is completed based on the gradient sum.

An execution process of the model training method does not require participation of a parameter server. Therefore, even if the parameter server is untrusted, related information of a training sample in the worker unit cannot be stolen, thereby ensuring information security of the training sample.

Based on the above-mentioned brief description of the model training method provided in this specification, the model training method provided in this specification can be applied to a training system that includes only a worker unit. All worker units in the training system can be different electronic devices, or can be different modules in a same electronic device. The electronic device can be an intelligent terminal, a server, etc. A specific type of the electronic device can be set based on a requirement. This is not limited in this specification.

Specifically, the training system can be a data-parallel federated learning system. That is, a complete network structure corresponding to a model is pre-deployed in each worker unit, and different training samples are stored in all the worker units. In this case, training can be performed in parallel in all the worker units based on the different training samples stored in all the worker units, and then a gradient obtained through training is shared, and a model parameter is adjusted based on the shared gradient.

Therefore, for each worker unit, the worker unit can determine data to be risk-controlled as a training sample based on sensitive data of a user stored in the worker unit, and determine a risk control result corresponding to the data to be risk-controlled as a label of the training sample. Therefore, the worker unit can use the training sample of the worker unit as an input, and input the training sample into a to-be-trained target model corresponding to the model training task, to obtain a predicted risk control result output by the target model.

Then, the worker unit can determine, based on the predicted risk control result and the label of the training sample, a loss corresponding to the training sample of the worker unit.

Finally, the worker unit can determine the gradient based on the loss corresponding to the training sample stored in the worker unit.

The target model includes a network structure and a model parameter of a model corresponding to the model training task. The network structure is pre-deployed in the worker unit, or is determined by the worker unit from stored network structures based on a model identifier corresponding to the model training task. The model parameter is adjusted by the worker unit based on a gradient sum determined after encrypted data is shared last time with another worker unit that executes the model processing task, or can be received by the worker unit and sent by another worker unit that executes the model processing task. Specifically, how to determine the network structure and the model parameter of the target model can be set based on a requirement. This is not limited in this specification.

It should be noted that the gradient in this specification can be a gradient of a loss determined by the worker unit based on the training sample, or can be an adjustment amount of a model parameter determined based on the gradient. That is, the gradient can be any adjustment amount that needs to be aggregated in a training process of the training system, to execute the model training task based on an aggregation result.

S102: Determine, by using the gradient as a parameter of an encryption function, an encryption function corresponding to the worker unit.

In one or more embodiments provided in this specification, a manner of using an encryption function to perform homomorphic encryption on gradients of all worker units that execute the model training task is used in this specification, to determine sliced encrypted data corresponding to the gradient. Further, a gradient sum of all the worker units that execute the model training task is decrypted based on the sliced encrypted data, and further the model training task is executed based on the gradient sum.

Based on this, the worker unit can determine an encryption function used to encrypt the gradient. The encryption function can be an encryption function for homomorphic encryption, for example, a Lagrange polynomial-based homomorphic encryption function.

Specifically, an encryption function paradigm can be preset in each worker unit in the training system. For example, the encryption function paradigm is ƒ(x)=ax+b. If x is an independent variable, and ƒ(x) is a dependent variable, a and b in the paradigm are parameters of the encryption function.

Therefore, the worker unit can determine, based on the preset encryption function paradigm and the gradient, a parameter required for generating the encryption function. That is, the worker unit can determine, based on the gradient, a parameter corresponding to the encryption function. The worker unit can directly use the gradient as at least one of parameters of the encryption function, or can perform homomorphic computation on the gradient, and then use a processing result as at least one of parameters of the encryption function. Specifically, how to determine, based on the gradient, the parameter required for generating the encryption function can be set based on a requirement. This is not limited in this specification. Homomorphic computation is a computation manner in the ciphertext domain. Homomorphic computation allows a specific form of algebraic computation to be performed on ciphertext, to still obtain an encrypted result. A result obtained by decrypting the encrypted result is the same as a result obtained by performing same computation on plaintext.

After determining the parameter required for generating the encryption function, the worker unit can determine, based on the parameter, an encryption function that uses the gradient as a parameter as the encryption function corresponding to the worker unit.

S104: For each specified value, determine, as first encrypted data based on the specified value and the encryption function, sliced encrypted data that is of the gradient and that corresponds to the specified value, where a quantity of specified values is not less than a quantity of worker units that execute the model training task.

In one or more embodiments provided in this specification, after the encryption function that uses the gradient as a parameter is determined, the encryption function is sliced at a specified value, and obtained sliced encrypted data is sliced encrypted data that is of the gradient and that corresponds to the specified value. On this basis, if sliced encrypted data that is of the gradients respectively corresponding to all the worker units and that corresponds to all the specified values is obtained, the gradient sum of all the worker units can be determined based on a homomorphic encryption principle. The above is the idea of using the encryption function to perform homomorphic encryption on the gradients of all the worker units that execute the model training task, as described above. Based on this, the worker unit can determine the sliced encrypted data.

Specifically, a plurality of specified values are preset in the worker unit. The quantity of the specified values is not less than the quantity of worker units that execute the model training task. Subsequently, the gradient sum of all the worker units can be decrypted based on the sliced encrypted data that is of the gradients and that corresponds to all the specified values.

Therefore, for each specified value, the worker unit can determine, based on the specified value and the encryption function, the sliced encrypted data that is of the gradient and that corresponds to the specified value. For example, the encryption function is ƒ(x)=ax+b, a and b are parameters of the encryption function, and b is the gradient determined by the worker unit. If the specified value is 1, the worker unit can determine, based on the encryption function and the specified value, sliced encrypted data ƒ(1), that is, a+b, that is of the gradient and that corresponds to the specified value.

Certainly, the sliced encrypted data can alternatively be [1,ƒ(1)]. A specific data form corresponding to the sliced encrypted data can be set based on a requirement. This is not limited in this specification.

In addition, to facilitate distinguishing between the sliced encrypted data corresponding to the gradient of the worker unit and sliced encrypted data corresponding to a gradient determined by another worker unit that executes the model processing task, the worker unit can use the sliced encrypted data corresponding to the gradient of the worker unit as first encrypted data.

S106: Receive sliced encrypted data that is sent by another worker unit, that is of a gradient of the another worker unit, and that corresponds to the specified value, and use the sliced encrypted data as second encrypted data.

In one or more embodiments provided in this specification, as described above, after the sliced encrypted data that is of the gradients respectively corresponding to all the worker units and that corresponds to all the specified values is obtained, the gradient sum of all the worker units can be obtained through decryption. Based on this, the worker unit can receive the sliced encrypted data sent by the another worker unit.

Specifically, the worker unit can send a first obtaining request to the another worker unit that executes the model training task.

The another worker unit sends the sliced encrypted data that is determined by the another worker unit, that is of the gradient, and that corresponds to the specified value to the worker unit based on the received first obtaining request.

The worker unit can receive the sliced encrypted data that is sent by the another worker unit, that is of the gradient of the another worker unit, and that corresponds to the specified value, and use the received sliced encrypted data that is of the gradient of the another worker unit and that corresponds to the specified value as the second encrypted data.

Certainly, for each worker unit, after the sliced encrypted data that is of the gradient of the worker unit and that corresponds to the specified value is determined, the sliced encrypted data that is of the gradient of the worker unit and that corresponds to the specified value can be sent to the another worker unit that executes the model training task. Therefore, the worker unit can directly receive the sliced encrypted data sent by the another worker unit for the model training task.

S108: Determine a gradient sum of the another worker unit and the worker unit through decryption based on sliced encrypted data corresponding to all the specified values, and execute the model training task based on the gradient sum.

In one or more embodiments provided in this specification, as described above, after the sliced encrypted data that is of the gradients respectively corresponding to all the worker units and that corresponds to all the specified values is determined, the gradient sum of all the worker units that execute the model training task can be decrypted. Subsequently, the model training task can be executed based on the gradient sum obtained through decryption.

Specifically, the worker unit can determine the sliced encrypted data, that is, the first encrypted data, that is of the gradient of the worker unit and that corresponds to the specified value, and receive the sliced encrypted data, that is, the second encrypted data, that is of the gradient of the another worker unit and that corresponds to the specified value.

Therefore, the worker unit can determine, based on the first encrypted data and the second encrypted data, all sliced encrypted data corresponding to the specified value. All the sliced encrypted data corresponding to the specified value is sliced encrypted data that is of the gradients of the worker units that execute the model training task and that corresponds to the specified value.

Then, the worker unit can determine sliced encrypted data corresponding to all the specified values. Therefore, for each specified value, all sliced encrypted data corresponding to the specified value can be considered as a result of encrypting different gradients by using different encryption functions and the same specified value. For each gradient, all sliced encrypted data corresponding to the gradient can be considered as a result of encrypting the gradient by using a same encryption function and different specified values.

Finally, the worker unit can obtain, through decryption based on the sliced encrypted data corresponding to all the specified values, the gradient sum of all the worker units that execute the data processing task, that is, the gradient sum of the another worker unit and the worker unit.

After obtaining the gradient sum through decryption, the worker unit can determine whether an iteration termination condition is met. The iteration termination condition can be that a quantity of iteration times reaches a preset threshold of a quantity of times, or can be that the loss determined in step S100 is less than a preset loss threshold. Specifically, how to set the iteration termination condition can be set based on a requirement. This is not limited in this specification.

If yes, the worker unit can determine that training of the model corresponding to the model training task is completed. That is, the current federated learning task ends.

If no, the worker unit can adjust, based on the determined gradient sum, a model parameter of the model corresponding to the model training task; and re-determine the gradient of the worker unit based on an adjusted model parameter and the training sample stored in the worker unit, re-determine the first encrypted data based on the determined gradient, and continue to determine, based on the re-determined first encrypted data, the gradient sum of all the worker units that execute the model training task, until the iteration termination condition is met.

That is, after determining that training of the model corresponding to the model training task is not completed, the worker unit can adjust, based on the determined gradient sum, the model parameter of the model deployed by the worker unit, determine a model gradient in a case of an adjusted model parameter based on the adjusted model parameter, and then re-determine, based on the determined gradient, the sliced encrypted data that is of the gradient and that corresponds to the specified value, to continue to complete gradient aggregation based on the sliced encrypted data corresponding to all the specified values, and continue to update the model parameter, so as to perform a next iteration process based on an updated model parameter. The iteration process is repeated until model training ends.

Therefore, a risk control model obtained through training based on the model training method can determine, in a process of executing a service by the user, a risk control result corresponding to the data that is to be risk-controlled and that is determined based on the sensitive data of the user, etc., and then perform risk control for the user based on the risk control result.

Based on the model training method provided in this specification, the gradients of all the worker units are encrypted by using a homomorphic encryption idea. Therefore, for each worker unit, after receiving the first encrypted data and the second encrypted data, the worker unit cannot directly determine a gradient of another worker unit, and can determine only a gradient sum of the another worker unit and the worker unit. Therefore, a training sample and a model parameter in the another worker unit cannot be inferred, thereby ensuring data security.

In the model training method shown in FIG. 1, for each worker unit in the training system, an encryption function is determined by using a gradient of the worker unit as a parameter; and sliced encrypted data that is of the gradient and that corresponds to a specified value is determined based on the encryption function. Further, a gradient sum of another worker unit and the worker unit is determined based on the sliced encrypted data that is of the gradient and that corresponds to the specified value and sliced encrypted data that is of a gradient of the another worker unit and that corresponds to the specified value, to complete gradient aggregation, and then a model training task is completed based on an aggregated gradient. An execution process of the model training method does not require participation of a parameter server. Therefore, even if the parameter server is untrusted, related information of a training sample and a model parameter in the worker unit cannot be stolen, thereby ensuring information security of the training sample and the model parameter.

In addition, in a process of training the risk control model based on the model training method in this specification, data security of sensitive data stored in all the worker units in the training system is ensured.

In addition, to ensure model training efficiency and avoid a case in which after the gradient sum of all the worker units that execute the model training task is re-determined, it is determined that execution of the model training task is completed, the above-mentioned step of determining that the iteration termination condition is met can alternatively be performed by the worker unit in step S100.

Further, in step S102, the worker unit can directly use the gradient as a parameter of the encryption function, randomly select any function that includes the parameter and an independent variable as the encryption function, and then broadcast a function type of the determined encryption function to another worker unit that executes the model training task.

The another worker unit can determine an encryption function of the another worker unit based on the received function type and a determined gradient of the another worker unit.

Further, for each piece of second encrypted data, in a process of transmitting the second encrypted data, the second encrypted data may be intercepted and tampered with. In this case, when the worker unit performs a subsequent step based on the received second encrypted data that is tampered with, an attacker that tampers with the second encrypted data may infer a training sample and a model parameter in the worker unit based on an execution result. To avoid occurrence of the above-mentioned case, before step S108, the worker unit can verify the second encrypted data after receiving the second encrypted data.

Specifically, the worker unit can further encrypt each parameter in the encryption function corresponding to the worker unit, determine a first encrypted parameter, and broadcast the first encrypted data and the first encrypted parameter. The encryption manner can be performing homomorphic computation on each parameter in the encryption function, or determining a signature of the worker unit based on each parameter in the encryption function.

Similarly, for each piece of second encrypted data, the worker unit can further receive a second encrypted parameter corresponding to the second encrypted data. An encryption manner of the second encrypted parameter is the same as an encryption manner of the first encrypted parameter. The second encrypted parameter is sent by a worker unit that sends the second encrypted data.

Therefore, the worker unit can verify the second encrypted data based on the second encrypted parameter. If the encryption manner of the second encrypted parameter is homomorphic computation, the worker unit can perform homomorphic computation processing on the second encrypted data, and determine whether a processing result is the same as a product of the second encrypted parameter, to verify the second encrypted data. If the encryption manner of the second encrypted parameter is only symmetric encryption or asymmetric encryption, the worker unit can infer, based on the encryption manner of the first encrypted parameter, plaintext corresponding to the second encrypted parameter. If the second encrypted parameter is a signature, the worker unit can verify the second encrypted data based on the received digital signature.

If the verification succeeds, the worker unit can determine that the second encrypted data is secure data, and can perform a subsequent step.

If the verification fails, the worker unit can determine that there is a potential security risk in the training system. That is, data transmitted by all the worker units in the training system may be intercepted by an attacker, or there is a worker unit that transmits incorrect data in all the worker units in the training system. Therefore, the worker unit can return prompt information used to indicate that there is a potential security risk in the training system.

In addition, as an important sampling model in cryptography, groups are often used to encrypt data. Therefore, in this specification, the encryption manner used to determine the first encrypted parameter and the second encrypted parameter can be a manner of performing encryption by using a generator of a group.

Specifically, the worker unit can first determine the generator. The worker unit can predefine a relatively large prime as a modulus prime, and determine a prime factor from a factor of a value corresponding to the modulus prime minus 1 as an order prime.

After determining the modulus prime and the order prime, the worker unit can construct a multiplicative cyclic group Zₚ={1, 2, . . . . . . , p−1} and determine a generator of the cyclic group. For example, if the modulus prime is p, the order prime is q, and the generator is g, g^{q}=e. That is, g is the generator of the multiplicative cyclic group, and an order is q.

Therefore, after the modulus prime, the order prime, and the generator are determined, the worker unit can broadcast the modulus prime, the order prime, and the generator as third encrypted data.

Another worker unit can verify the received third encrypted data. That is, the third encrypted data is verified based on any one of conditions such as whether g is the generator of the multiplicative cyclic group and the order is q holds, whether the order prime is a prime, and whether the modulus prime is a prime.

If the verification succeeds, the another worker unit can subsequently encrypt the parameter of the encryption function based on the generator.

If the verification fails, the another worker unit can send prompt information used to indicate that there is a potential security risk in the training system.

After the verification succeeds, for each worker unit, the worker unit can encrypt the gradient of the worker unit by using the generator as a base, using the parameter as an exponent, and performing a modulo operation on a corresponding result based on the modulus prime.

For example, the encryption function of the worker unit is ƒ(x)=ax+b, a and b are parameters of the encryption function, and b is the gradient determined by the worker unit. If the specified value is 1, the worker unit can determine sliced encrypted data ƒ(1), that is, a+b, at the specified value. In this case, first encrypted parameters corresponding to the worker unit are g^{a} and g^{b}.

Therefore, the another worker unit can receive the sliced encrypted data of the worker unit and the first encrypted parameter corresponding to the sliced encrypted data, and verify the received sliced encrypted data based on the first encrypted parameter.

Further, a common homomorphic encryption manner is to perform same processing on different data. Subsequently, a sum of the different data is back-computed based on a sum of processing results of the different data. Similarly, in step S110 in this specification, the worker unit can also decrypt, based on the principle, the gradient sum of all the worker units that execute the model training task.

Specifically, for each specified value, the worker unit can perform summation on sliced encrypted data corresponding to the specified value, to obtain a sum of the sliced encrypted data corresponding to the specified value.

Therefore, the worker unit can decrypt, based on the homomorphic encryption principle and sums of sliced encrypted data respectively corresponding to all the specified values, the gradient sum of all the worker units that execute the model training task.

For example, there is a worker unit 1 and a worker unit 2 in the training system. It is assumed that an encryption function corresponding to the worker unit 1 is ƒ₁(x)=a₁x+a₂, an encryption function corresponding to the worker unit 2 is ƒ₂(x)=b₁x+b₂, and a₂ and b₂ are respectively gradients of the worker unit 1 and the worker unit 2. If the specified values are 1 and 2, a sum of sliced encrypted data corresponding to the specified value 1 is ƒ₁(1)+ƒ₂(1)=a₁+b₁+a₂+b₂, and a sum of sliced encrypted data corresponding to the specified value 2 is ƒ₁(2)+ƒ₂(2)=2a₁+2b₁+a₂+b₂. Therefore, a specific value corresponding to a gradient sum a₂+b₂ of the worker unit 1 and the worker unit 2 can be determined based on the sum of the sliced encrypted data corresponding to the specified value 1 and the sum of the sliced encrypted data corresponding to the specified value 2. Subsequently, the model training task can continue to be executed based on the gradient sum.

It should be noted that the quantity of specified values is not less than the quantity of worker units that execute the model training task, because only when sliced encrypted data of the quantity of worker units that execute the model training task is obtained, an accurate gradient sum of all the worker units can be obtained through decryption. In addition, if a same gradient corresponds to an excessively small quantity of pieces of sliced encrypted data, the worker unit can further obtain the gradient sum through decryption. In this case, security of the sliced encrypted data is clearly not high enough. Therefore, to ensure security, the quantity of specified values is set to be not less than the quantity of worker units that execute the model training task.

Further, for each worker unit, if a gradient sum determined by the worker unit is inconsistent with a gradient sum determined by the another worker unit, there may be a potential security risk in the training system.

Specifically, for each worker unit, the worker unit can send a second obtaining request to the another worker unit that executes the model training task. The second obtaining request is used to obtain the gradient sum determined by the another worker unit.

The another worker unit can return the gradient sum determined by the another worker unit to the worker unit based on the received second obtaining request.

Therefore, the worker unit can determine whether the received gradient sum sent by the another worker unit is consistent with the gradient sum determined by the worker unit.

If the received gradient sum sent by the another worker unit is consistent with the gradient sum determined by the worker unit, the worker unit can continue to execute the model training task based on the determined gradient sum.

If the received gradient sum sent by the another worker unit is inconsistent with the gradient sum determined by the worker unit, the worker unit can send prompt information used to indicate that there is a potential security risk in the training system.

In addition, in consideration of security of the training sample stored in the worker unit, to avoid a case in which information disclosure is caused because it cannot be discovered, in a timely manner, that there is a potential security risk in the training system, for each specified value, the worker unit can further verify, by using the first encrypted parameter and the second encrypted parameter, a sum of sliced encrypted data corresponding to the specified value.

Specifically, for each specified value, the worker unit can determine the sum of the sliced encrypted data corresponding to the specified value.

Then, the worker unit can verify, based on the first encrypted parameter and the second encrypted parameter, the sum of the sliced encrypted data corresponding to the specified value.

Finally, after verification on each of sums of the sliced encrypted data corresponding to all the specified values succeeds, the worker unit obtains the gradient sum of the worker unit and the another worker unit through decryption based on the sums of the sliced encrypted data corresponding to all the specified values.

If any verification result is that the verification fails, the worker unit can send prompt information used to indicate that there is a potential security risk in the training system.

Further, in this specification, each worker unit can receive only sliced encrypted data that is of a target value and that corresponds to the worker unit. The worker unit is configured to complete aggregation of the sliced encrypted data that is of the target value and that corresponds to the worker unit. That is, the worker unit is configured to determine a sum of the sliced encrypted data that is of the target value and that corresponds to the worker unit.

Therefore, the worker unit can further receive a sum of sliced encrypted data that is sent by another worker unit, that is of the target value, and that corresponds to the another worker unit, and determine, based on the received sum of the sliced encrypted data that is of the target value and that corresponds to the another worker unit, the sums of the sliced encrypted data corresponding to all the specified values.

It should be noted that all actions of obtaining a signal, information, or data in this specification are performed in compliance with corresponding data protection regulations and policies of the local country, and are authorized by owners of corresponding apparatuses.

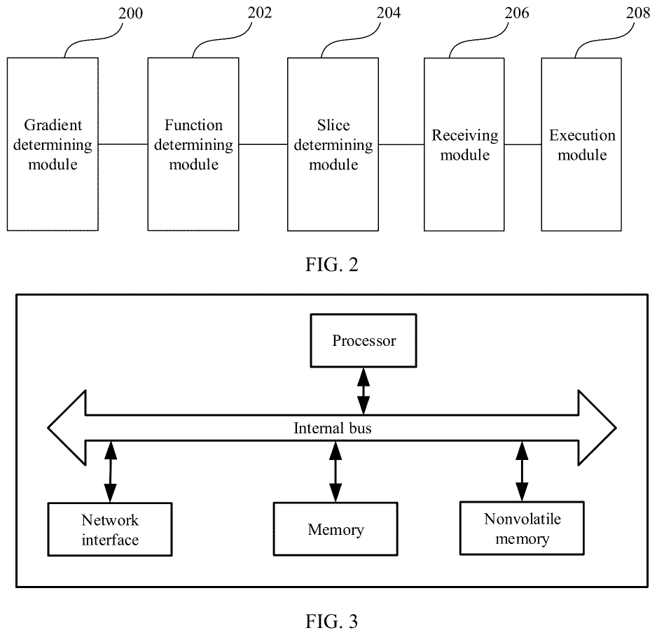

Based on a same idea, this specification further provides a model training apparatus, as shown in FIG. 2.

FIG. 2 shows a model training apparatus according to this specification. The apparatus is applied to a model training system, the training system includes several worker units, and each worker unit stores a different training sample. A gradient determining module 200 is configured to: for each worker unit, determine, in response to a model training task, a gradient based on the training sample stored in the worker unit.

A function determining module 202 is configured to determine, by using the gradient as a parameter of an encryption function, an encryption function corresponding to the worker unit.

A slice determining module 204 is configured to: for each specified value, determine, as first encrypted data based on the specified value and the encryption function, sliced encrypted data that is of the gradient and that corresponds to the specified value, where a quantity of specified values is not less than a quantity of worker units that execute the model training task.

A receiving module 206 is configured to: receive sliced encrypted data that is sent by another worker unit, that is of a gradient of the another worker unit, and that corresponds to the specified value, and use the sliced encrypted data as second encrypted data.

An execution module 208 is configured to: determine a gradient sum of the another worker unit and the worker unit based on sliced encrypted data corresponding to all the specified values, and execute the model training task based on the gradient sum.

Optionally, the function determining module 202 is configured to: determine, based on a preset encryption function paradigm and the gradient, a parameter required for generating the encryption function; and determine, based on the parameter, an encryption function that uses the gradient as a parameter as the encryption function corresponding to the worker unit.

Optionally, before the gradient sum of the another worker unit and the worker unit is obtained through decryption based on the sliced encrypted data corresponding to all the specified values, the receiving module 206 is configured to: encrypt each parameter in the encryption function, determine a first encrypted parameter, and broadcast the first encrypted data and the first encrypted parameter; for each piece of second encrypted data, receive a second encrypted parameter corresponding to the second encrypted data, where an encryption manner of the second encrypted parameter is the same as an encryption manner of the first encrypted parameter, and the second encrypted parameter is sent by a worker unit that sends the second encrypted data; and determine, based on the second encrypted parameter, that verification on the second encrypted data succeeds.

Optionally, the execution module 208 is configured to: for each specified value, determine a sum of all sliced encrypted data corresponding to the specified value; and decrypt the gradient sum of the another worker unit and the worker unit based on sums of the sliced encrypted data respectively corresponding to all the specified values.

Optionally, the execution module 208 is configured to: adjust a model parameter in the worker unit based on the gradient sum; and re-determine the gradient based on an adjusted model parameter and the training sample stored in the worker unit, re-determine the first encrypted data based on the re-determined gradient, and continue to determine, based on the re-determined first encrypted data, a gradient sum of all worker units that execute the model training task, until an iteration termination condition is met.

Optionally, the execution module 208 is configured to: receive a gradient sum that is sent by the another worker unit and that is obtained by the another worker unit through decryption; determine whether a gradient sum obtained by the worker unit through decryption is consistent with the gradient sum obtained by the another worker unit through decryption; and if yes, execute the model training task; or if no, send prompt information used to indicate that there is a potential security risk in the training system.

Optionally, the execution module 208 is configured to: for each specified value, verify, based on the first encrypted parameter and the second encrypted parameter, a sum of sliced encrypted data corresponding to the specified value; and after verification on each of sums of the sliced encrypted data corresponding to all the specified values succeeds, obtain the gradient sum of the another worker unit and the worker unit through decryption based on the sums of the sliced encrypted data corresponding to all the specified values.

This specification further provides a non-transitory computer-readable storage medium. The storage medium stores a computer program, and the computer program can be used to perform the model training method provided in FIG. 1.

This specification further provides a schematic structural diagram of an electronic device shown in FIG. 3. As shown in FIG. 3, in terms of hardware, the electronic device includes a processor, an internal bus, a network interface, a memory, and a nonvolatile memory, and certainly can further include hardware needed by another service. The processor reads a corresponding computer program from the nonvolatile memory into the memory and then runs the computer program, to implement the model training method shown in FIG. 1. Certainly, in addition to software implementations, another implementation is not excluded in this specification, for example, a logic device or a combination of hardware and software. In other words, an execution body of the following processing procedures is not limited to logical units or application containers, and can be hardware or a logic device.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and manufacture an application-specific integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). Currently, the Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using some described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. A storage controller can also be implemented as a part of control logic of a storage. A person skilled in the art also knows that in addition to implementing the controller by using only the computer-readable program code, logic programming can be performed on method steps to enable the controller to implement a same function in a form of a logic gate, a switch, an application-specific integrated circuit, a programmable logic controller, an embedded microcontroller, etc. Therefore, the controller can be considered as a hardware component, and an apparatus included in the controller for implementing various functions can also be considered as a structure in the hardware component. Alternatively, the apparatus configured to implement various functions can even be considered as both a software module implementing the method and a structure in the hardware component.

The system, apparatus, module, or unit described in the above-mentioned embodiments can be specifically implemented by a computer chip or an entity, or can be implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatuses are described by dividing the apparatus into various units based on functions. Certainly, when this specification is implemented, functions of the units can be implemented in one or more pieces of software and/or hardware.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, a form of a computer program product that is implemented on one or more computer-usable storage media (including but not limited to a disk memory, a CD-ROM, an optical memory, etc.) that include computer-usable program code can be used in this specification.

This specification is described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable storage that can instruct a computer or another programmable data processing device to work in a specific manner, so that the instructions stored in the computer-readable storage generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), an input/output interface, a network interface, and a memory.

The memory may include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer-readable medium includes persistent, non-persistent, removable and non-removable media that can store information by using any method or technology. The information can be computer-readable instructions, a data structure, a program module, or other data. Examples of the computer storage medium include but are not limited to a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage or another magnetic storage device, or any other non-transmission medium. The computer storage medium can be configured to store information accessible by the computing device. Based on the definition in this specification, the computer-readable medium does not include a transitory computer-readable medium such as a modulated data signal and carrier.

It should be further noted that the terms “include”, “comprise”, or any other variants thereof are intended to cover a non-exclusive inclusion, so that a process, a method, a product, or a device that includes a list of elements not only includes those elements but also includes other elements which are not expressly listed, or further includes elements inherent to such a process, method, product, or device. Without more constraints, an element preceded by “includes a . . . ” does not preclude the presence of additional identical elements in the process, method, product, or device that includes the element.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, a form of a computer program product that is implemented on one or more computer-usable storage media (including but not limited to a disk memory, a CD-ROM, an optical memory, etc.) that include computer-usable program code can be used in this specification.

This specification can be described in the general context of computer-executable instructions executed by a computer, for example, a program module. Usually, the program module includes a routine, a program, an object, a component, a data structure, etc. for executing a specific task or implementing a specific abstract data type. This specification can alternatively be practiced in distributed computing environments. In the distributed computing environments, tasks are executed by remote processing devices connected through a communication network. In the distributed computing environments, the program module can be located in both local and remote computer storage media including storage devices.

The embodiments of this specification are described in a progressive manner. For same or similar parts of the embodiments, refer to the embodiments. Each embodiment focuses on a difference from other embodiments. Particularly, the system embodiments are basically similar to the method embodiments, and therefore are described briefly. For related parts, refer to some descriptions in the method embodiments.

The above-mentioned descriptions are merely embodiments of this specification, and are not intended to limit this specification. A person skilled in the art can make various changes and variations to this specification. Any modifications, equivalent replacements, improvements, etc. made without departing from the spirit and principle of this specification shall fall within the scope of the claims of this specification.

1. A model training method, wherein the method is applied to a training system, the training system comprises several worker units, each worker unit stores a different training sample, and the method comprises:
for each worker unit, determining, in response to a model training task, a gradient based on the training sample stored in the worker unit;
determining, by using the gradient as a parameter of an encryption function, an encryption function corresponding to the worker unit;
for each specified value, determining, as first encrypted data based on the specified value and the encryption function, sliced encrypted data that is of the gradient and that corresponds to the specified value, wherein a quantity of specified values is not less than a quantity of worker units that execute the model training task;
receiving sliced encrypted data that is sent by another worker unit, that is of a gradient of the another worker unit, and that corresponds to the specified value, and using the sliced encrypted data as second encrypted data; and
obtaining a gradient sum of the another worker unit and the worker unit through decryption based on sliced encrypted data corresponding to all the specified values, and executing the model training task based on the gradient sum.

2. The method according to claim 1, wherein the determining, based on the gradient by using the gradient as a parameter of an encryption function, an encryption function corresponding to the worker unit specifically comprises:
determining, based on a preset encryption function paradigm and the gradient, a parameter required for generating the encryption function; and
determining, based on the parameter, an encryption function that uses the gradient as a parameter as the encryption function corresponding to the worker unit.

3. The method according to claim 1, wherein before the obtaining a gradient sum of the another worker unit and the worker unit through decryption based on sliced encrypted data corresponding to all the specified values, the method further comprises:
encrypting each parameter in the encryption function, determining a first encrypted parameter, and broadcasting the first encrypted data and the first encrypted parameter;
for each piece of second encrypted data, receiving a second encrypted parameter corresponding to the second encrypted data, wherein an encryption manner of the second encrypted parameter is the same as an encryption manner of the first encrypted parameter, and the second encrypted parameter is sent by a worker unit that sends the second encrypted data; and
determining, based on the second encrypted parameter, that verification on the second encrypted data succeeds.

4. The method according to claim 1, wherein the obtaining a gradient sum of the another worker unit and the worker unit through decryption based on sliced encrypted data corresponding to all the specified values specifically comprises:
for each specified value, determining a sum of all sliced encrypted data corresponding to the specified value; and
decrypting the gradient sum of the another worker unit and the worker unit based on sums of the sliced encrypted data respectively corresponding to all the specified values.

5. The method according to claim 1, wherein the executing the model training task based on the gradient sum specifically comprises:
adjusting a model parameter in the worker unit based on the gradient sum; and
re-determining the gradient based on an adjusted model parameter and the training sample stored in the worker unit, re-determining the first encrypted data based on the re-determined gradient, and continuing to determine, based on the re-determined first encrypted data, a gradient sum of all worker units that execute the model training task, until an iteration termination condition is met.

6. The method according to claim 1, wherein before the executing the model training task based on the gradient sum, the method further comprises:
receiving a gradient sum that is sent by another worker unit and that is obtained by the another worker unit through decryption;
determining whether a gradient sum obtained by the worker unit through decryption is consistent with the gradient sum obtained by the another worker unit through decryption; and
if yes, executing the model training task; or
if no, sending prompt information used to indicate that there is a potential security risk in the training system.

7. The method according to claim 3, wherein the obtaining a gradient sum of the another worker unit and the worker unit through decryption based on sliced encrypted data corresponding to all the specified values specifically comprises:
for each specified value, verifying, based on the first encrypted parameter and the second encrypted parameter, a sum of sliced encrypted data corresponding to the specified value; and
after verification on each of sums of the sliced encrypted data corresponding to all the specified values succeeds, obtaining the gradient sum of the another worker unit and the worker unit through decryption based on the sums of the sliced encrypted data corresponding to all the specified values.

8-9. (canceled)

10. An electronic device, comprising a storage, a processor, and a computer program that is stored in the storage and that is capable of running on the processor, wherein when the processor executes the program, the electronic device is caused to:
for each worker unit, determine, in response to a model training task, a gradient based on the training sample stored in the worker unit;
determine, by using the gradient as a parameter of an encryption function, an encryption function corresponding to the worker unit;
for each specified value, determine, as first encrypted data based on the specified value and the encryption function, sliced encrypted data that is of the gradient and that corresponds to the specified value, wherein a quantity of specified values is not less than a quantity of worker units that execute the model training task;
receive sliced encrypted data that is sent by another worker unit, that is of a gradient of the another worker unit, and that corresponds to the specified value, and using the sliced encrypted data as second encrypted data; and
obtain a gradient sum of the another worker unit and the worker unit through decryption based on sliced encrypted data corresponding to all the specified values, and execute the model training task based on the gradient sum.

11. The electronic device according to claim 10, wherein the electronic device being caused to determine, based on the gradient by using the gradient as a parameter of an encryption function, an encryption function corresponding to the worker unit specifically comprises being caused to:
determine, based on a preset encryption function paradigm and the gradient, a parameter required for generating the encryption function; and
determine, based on the parameter, an encryption function that uses the gradient as a parameter as the encryption function corresponding to the worker unit.

12. The electronic device according to claim 10, wherein before the electronic device being caused to obtain a gradient sum of the another worker unit and the worker unit through decryption based on sliced encrypted data corresponding to all the specified values, the electronic device is further caused to:
encrypt each parameter in the encryption function, determine a first encrypted parameter, and broadcast the first encrypted data and the first encrypted parameter;
for each piece of second encrypted data, receive a second encrypted parameter corresponding to the second encrypted data, wherein an encryption manner of the second encrypted parameter is the same as an encryption manner of the first encrypted parameter, and the second encrypted parameter is sent by a worker unit that sends the second encrypted data; and
determine, based on the second encrypted parameter, that verification on the second encrypted data succeeds.

13. The electronic device according to claim 10, wherein the electronic device being caused to obtain a gradient sum of the another worker unit and the worker unit through decryption based on sliced encrypted data corresponding to all the specified values specifically comprises being caused to:
for each specified value, determine a sum of all sliced encrypted data corresponding to the specified value; and
decrypt the gradient sum of the another worker unit and the worker unit based on sums of the sliced encrypted data respectively corresponding to all the specified values.

14. The electronic device according to claim 10, wherein the electronic device being caused to execute the model training task based on the gradient sum specifically comprises being caused to:
adjust a model parameter in the worker unit based on the gradient sum; and
re-determine the gradient based on an adjusted model parameter and the training sample stored in the worker unit, re-determine the first encrypted data based on the re-determined gradient, and continue to determine, based on the re-determined first encrypted data, a gradient sum of all worker units that execute the model training task, until an iteration termination condition is met.

15. The electronic device according to claim 10, wherein before the electronic device being caused to execute the model training task based on the gradient sum, the electronic device is further caused to:
receive a gradient sum that is sent by another worker unit and that is obtained by the another worker unit through decryption;
determine whether a gradient sum obtained by the worker unit through decryption is consistent with the gradient sum obtained by the another worker unit through decryption; and
if yes, execute the model training task; or
if no, send prompt information used to indicate that there is a potential security risk in the training system.

16. The electronic device according to claim 12, wherein the electronic device being caused to obtain a gradient sum of the another worker unit and the worker unit through decryption based on sliced encrypted data corresponding to all the specified values specifically comprises being caused to:
for each specified value, verify, based on the first encrypted parameter and the second encrypted parameter, a sum of sliced encrypted data corresponding to the specified value; and
after verification on each of sums of the sliced encrypted data corresponding to all the specified values succeeds, obtain the gradient sum of the another worker unit and the worker unit through decryption based on the sums of the sliced encrypted data corresponding to all the specified values.

17. A non-transitory computer-readable storage medium, wherein the non-transitory computer-readable storage medium stores a computer program, and when the computer program is executed by a processor, the processor is caused to:
for each worker unit, determine, in response to a model training task, a gradient based on the training sample stored in the worker unit;
determine, by using the gradient as a parameter of an encryption function, an encryption function corresponding to the worker unit;
for each specified value, determine, as first encrypted data based on the specified value and the encryption function, sliced encrypted data that is of the gradient and that corresponds to the specified value, wherein a quantity of specified values is not less than a quantity of worker units that execute the model training task;
receive sliced encrypted data that is sent by another worker unit, that is of a gradient of the another worker unit, and that corresponds to the specified value, and using the sliced encrypted data as second encrypted data; and
obtain a gradient sum of the another worker unit and the worker unit through decryption based on sliced encrypted data corresponding to all the specified values, and execute the model training task based on the gradient sum.

18. The non-transitory computer-readable storage medium according to claim 17, wherein the processor being caused to determine, based on the gradient by using the gradient as a parameter of an encryption function, an encryption function corresponding to the worker unit specifically comprises being caused to:
determine, based on a preset encryption function paradigm and the gradient, a parameter required for generating the encryption function; and
determine, based on the parameter, an encryption function that uses the gradient as a parameter as the encryption function corresponding to the worker unit.

19. The non-transitory computer-readable storage medium according to claim 17, wherein before the processor being caused to obtain a gradient sum of the another worker unit and the worker unit through decryption based on sliced encrypted data corresponding to all the specified values, the processor is further caused to:
encrypt each parameter in the encryption function, determine a first encrypted parameter, and broadcast the first encrypted data and the first encrypted parameter;
for each piece of second encrypted data, receive a second encrypted parameter corresponding to the second encrypted data, wherein an encryption manner of the second encrypted parameter is the same as an encryption manner of the first encrypted parameter, and the second encrypted parameter is sent by a worker unit that sends the second encrypted data; and
determine, based on the second encrypted parameter, that verification on the second encrypted data succeeds.

20. The non-transitory computer-readable storage medium according to claim 17, wherein the processor being caused to obtain a gradient sum of the another worker unit and the worker unit through decryption based on sliced encrypted data corresponding to all the specified values specifically comprises being caused to:
for each specified value, determine a sum of all sliced encrypted data corresponding to the specified value; and
decrypt the gradient sum of the another worker unit and the worker unit based on sums of the sliced encrypted data respectively corresponding to all the specified values.

21. The non-transitory computer-readable storage medium according to claim 17, wherein the processor being caused to execute the model training task based on the gradient sum specifically comprises being caused to:
adjust a model parameter in the worker unit based on the gradient sum; and
re-determine the gradient based on an adjusted model parameter and the training sample stored in the worker unit, re-determine the first encrypted data based on the re-determined gradient, and continue to determine, based on the re-determined first encrypted data, a gradient sum of all worker units that execute the model training task, until an iteration termination condition is met.

22. The non-transitory computer-readable storage medium according to claim 17, wherein before the processor being caused to execute the model training task based on the gradient sum, the processor is further caused to:
receive a gradient sum that is sent by another worker unit and that is obtained by the another worker unit through decryption;
determine whether a gradient sum obtained by the worker unit through decryption is consistent with the gradient sum obtained by the another worker unit through decryption; and
if yes, execute the model training task; or if no, send prompt information used to indicate that there is a potential security risk in the training system.
